(19) United States
(12) Patent Application Publication
(10) Pub. No.: US 2018/0075229 A1
(43) Pub. Date: Mar. 15, 2018

(54) Electronic Barcode Badge for Employee Access

(71) Applicant: NOVAtime Technology Inc., Diamond Bar, CA (US)

(72) Inventor: Joyce Jan, Brea, CA (US)

(21) Appl. No.: 15/564,685

(22) PCT Filed: Mar. 29, 2016
(86) PCT No.: PCT/US16/24787

§ 371 Date: Oct. 5, 2017

Related U.S. Application Data
(60) Provisional application No. 62/144,652, filed on Apr. 8, 2015.

(51) Int. Cl. G06F 21/35; G06F 17/30; G06K 19/06; G06K 7/10; H04L 29/06

(52) U.S. Cl. CPC G06F 21/35; G06F 17/30879; H04L 63/0853; G06K 7/1095; G06K 19/06037

(57) ABSTRACT

An electronic security clearance system and method that comprises generating an electronic badge, sending the digital badge to an employee, and verifying the electronic badge at a reader. The digital badge is embedded with information that controls access by time, location, and security. The present invention is directed to providing a cost effective security clearance system and method that efficiently generates security clearance identification (e.g. for temporary workers), and provides additional control features an employer might desire.

### TECHNICAL FIELD

This invention relates to security clearance using electronic badges in conjunction with scanners.

### BACKGROUND

Security clearance for employees, temporary workers, and other contractors is a regular cost center for routine business. As workers are hired, management must generate hardware to get into the job site, such as keys, identification, and near field communication (NFC) badges, and present the hardware to the employee. As workers are fired, resign, or are otherwise terminated, management must collect the hardware, while hoping the employee has not made copies. This process is neither efficient nor cost effective. This is particularly draining on businesses that hire temporary workers.

In the past, security clearance has often involved printed documentation with photographic identification, swipe cards, NFC devices, and other physical forms of identification that may require hiring of additional security personnel for effective use. Such items can be time-consuming and expensive to generate, and are limited in the security and information they are able to provide.

For the foregoing reasons, there is a need for a security clearance system that reduces the time and cost needed to generate security clearance for individuals, the system also being capable of providing increased control over security clearance parameters on an individualized basis.

The present invention is directed to providing a cost effective security clearance system and method that efficiently generates security clearance identification (e.g. for temporary workers), and provides additional control features an employer might desire. The security clearance system and method comprises a system and method for generating a digital badge that has associated with it, or is otherwise encoded or embedded with, identifying information, dates, hours, and locations for whether an admittee (e.g. employee, contactor, visitor, and the like) is authorized to have access to a particular site. The digital badge is sent to the admittee's mobile device, and the admittee is verified at the site by displaying the digital badge on his or her mobile device for scanning with a reader, such as is barcode scanner.

It is an object of the present invention to reduce hardware expenses in security clearance. These days, the vast majority of the population owns a smartphone. Rather than sinking costs into expensive hardware (e.g. security badges, swipe cards, photographic identification, etc.) for every individual requiring access to a facility, such as an employee, it is more cost-effective for a company to issue digital badges that can be transmitted and displayed on the admittee's (e.g. employee's or other worker's) smartphone or other mobile device. This system has the added benefit of reducing costs and security risks associated with lost security clearance, as well as the inconvenience when admittees forget the security clearance for the day, as people are much less likely to lose their smartphones.

It is an object of the present invention to increase efficiency in generating security clearance for workers and others who need to be admitted onto a facility. With the present invention, an employee can be authorized instantaneously to access a job site without the need for special hardware to be prepared. Additionally, a company's security detail does not need to collect any hardware when employment or contract work is terminated.

It is as object of the present invention to provide control tools related so managing the security clearance of employees and other workers. In a preferred embodiment, a digital badge may embed information regarding worker identification, the effective time period of the badge (i.e., the start date of a worker's assignment to a company, if temporary, the badge may expire), the days of the week and time of day that a worker may be on the premises, and the job site or subsection of a job site if the employer has multiple job sites or levels of security clearance.

These and other features, aspects, and advantages of the present invention will become better understood with reference to the following description and appended claims.

### BRIEF DESCRIPTION OF THE DRAWINGS

FIG. 1 shows an embodiment of the present invention.

FIG. 2 shows an embodiment of a handheld reader.

FIG. 3 shows an embodiment of a fixed reader.

FIG. 4 shows a high-level diagram of a computer that may be used to implement various aspects of the present disclosure in certain embodiments.

### DETAILED DESCRIPTION OF THE INVENTION

The detailed description set forth below in connection with the appended figures and attachments is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent fractions and sequences may be accomplished by different embodiments that are also intended to be encompassed within the spirit and scope of the invention.

A facility may want to limit access to a person being considered for admittance onto the facility (“admittee”). The limitation on admittance may be a temporal restriction (meaning restricting the day or time of access) and/or a locational restriction (meaning restriction to certain sites within the facility). Current methods for limiting access to a site utilize smart cards or other hardware that have to be manufactured and distributed, then collected when access is no longer authorized. The invention of the present application is a method and system for restricting a person's access to a facility, using a digital badge system that can be easily generated, delivered, modified, and inactivated without having to manufacture cards, fobs, chips, and like hardware.

The digital badge system is a system and method of verifying admittees by generating a digital badge associated with an admittee information, such as identification information, effective time period information, security credentials, and the like; providing the digital badge to the admittee; and authenticating the digital badge with a reader located at a site (e.g., a place of business). Facilities can utilize the system to provide admittees, such as workers or visitors, with limited access to a secure site. Admittees may be any visitor or worker needing access to the facility, such as, but not limited to, employees, independent contractors, regulatory personnel, inspectors, investors, shareholders, repair and maintenance, friends, family, or any other person who should only have a limited access to the site.

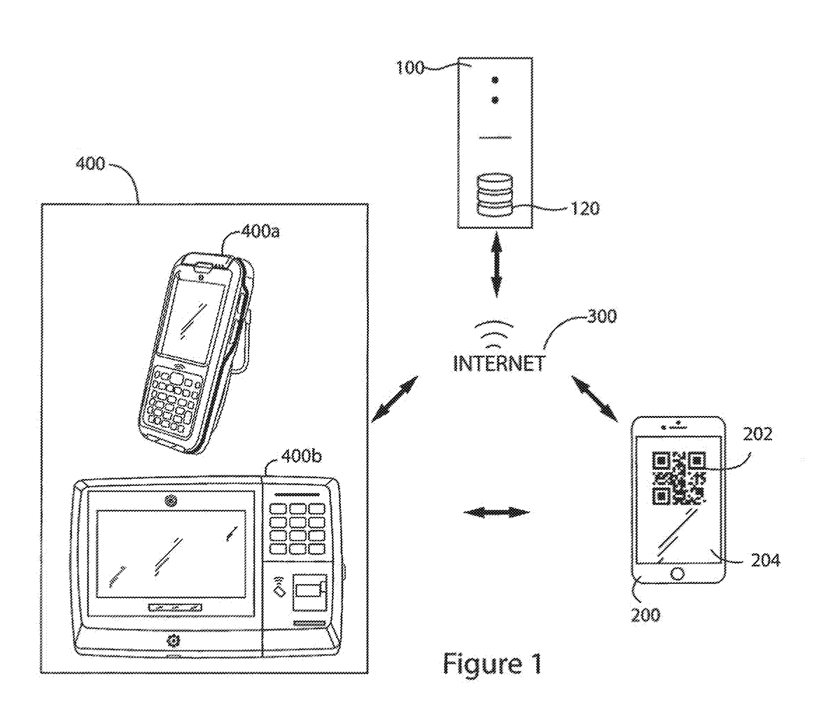

As shown in FIG. 1, systems and methods described herein may be used within a network-based cloud computing system. In such a network-based cloud computing system, a server 100 or another processor that is connected to a network communicates with one or more client devices 200 via a network 300. For example, a client device 200 may communicate with the server 100 via the network 300, wherein the server 100 stores employee authorization information in a database 102. The client device 200 may request the server 100 to generate the digital badge 202. The server 100 can then electronically send the digital badge 202 to the client device 200.

The client device 200 may be any electronic device possessed by the client that can connect with the server 100 to send and receive communications from the server 100. For example, the client device 200 may be a computer, a smartphone, a tablet, a phablet, a personal digital assistant, a smart watch, and the like, and any combination thereof. In one embodiment, the server 100 may communicate with a client mobile phone via the network 300 to send the digital badge 202. In another embodiment, the server 100 may send the digital badge 202 to a client computer, which can then send the digital badge 202 to the client mobile phone. Once the digital badge 202 is received by the client device 200, a reader 400 can scan the digital badge 202 and communicate with the server 100 via the network 300 in order to verify the information that the reader 400 has received and processed. Therefore, the digital badge 202 can be electronically delivered to the client device 200 at any time and any any location instantaneously.

In a preferred embodiment, an authorized administrator (e.g., of an employer) may generate the digital badge 202 that may be displayed on the client device 200. For example, the digital badge 202 may be a two-dimensional barcode, such as a QR code, wherein relevant user information is embedded and may be retrieved by a reader 400 seaming the digital badge 302. An admittee can receive the digital badge 202 via a variety of communication modes. For example, the authorized administrator may manually or automatically send the digital badge 202 to an admittee (e.g. employee or worker) via email, including email attachment, text, including text attachments, or a proprietary phone application so that the admittee can be provided with the digital badge 202 and have access to the site to begin work. In some embodiments, the email, text, or app may have a hyperlink to a secured website where the admittee can download the digital badge 202. Alternatively, the admittee can go to an established website directly and login to download the digital badge 202 directly to the client device 200.

The admittee then displays the digital badge 202 on his or her client device 200 at a suitable reader 400 at a job location. The reader 400 is connected to the server 100 via a network 300 and authenticates the digital badge 202 and provides the requisite access to the site for the admittee.

The system generates the digital badge 202. The digital badge 202 may be generated using software to embed relevant information at an authorized administrator's computer terminal connected to a server 100 via a network 300 like the Internet. In preferred embodiments, the digital badge 202 is a two-dimensional barcode, such as a QR code, with capabilities for embedding information in an image. The digital badge 202 must have visually identifiable information that is reeognizable by a reader 400, such as a NOVAtime® NT65M with 2D imager scanner. A benefit of using a two-dimensional barcode is that information may be embedded within the barcode image.

In preferred embodiments, the information embedded with the digital badge 202 may comprise the admittee's identification, time period of the digital badge effectiveness (e.g., the length of the assignment and permitted times of a given day), accessible location and sites, and any other restrictions or access.

Identification information may comprise the admittee's ID number, name, description, picture, phone number, car license plate, or any other feature for identifying the admittee. In situations where there is a security station with a guard, the admittee's information may be displayed on a screen of either the client device 200, the reader 400, or some other nearby computer so the guard can quickly verify the identity of the admittee by appearance.

The time period of the digital badge 202 effectiveness determines when the digital badge 202 may be used to access designated sites to a facility. For example, the time period may include the hours in which an admittee may clock in or clock out, such as from 8 a.m. to 6 p.m. from Monday to Friday. The time period may also include dates of employment. For example, an employee might be given security clearance for a fixed period of time, such as from Apr. 1, 2015 to Apr. 14, 2015. This is especially useful when dealing with temporary workers so that they do not have access to a facility past an expiration date. In addition, the time restriction can be used to prevent employees from clocking in his or her total work hours that exceed a predefined limit of maximum hours.

The location/site of the security clearance is useful for facilities that wish to only provide limited access to admittees. For example, an employer may have three facilities and wishes to only give an employee access to one facility. In another example, a worker may only be given access to particular locations within a site (e.g., a building), and the security clearance may restrict access to particular areas within a site (e.g. specific floor or room). In still another example, an employer may have large servers with different levels of security clearance for different data, and the employer may want the employee to have access to a small subset of the files. In a further example, the information may comprise a geofence that only allows clearance when the employee is within a certain area.

Additional security features may be implemented to verify the identity of the admittee. In some embodiments, an application for a client device 200 may be installed on an admittee's smartphone so that the digital badge 202 may only be accessed from a phone matching the admiytee's phone number. In other embodiments, the digital badge 202 may be encoded with a flag so that the admittee must be verified by security personnel. For example, after being scanned, the reader 400 may display the message “Employee: John Smith, Verify ID.” The security guard with the reader 400 will then verify that the admittee matches the identification information. In preferred embodiments, the reader 400 can connect to the server 100 via the Internet 300 in order to pull up additional relevant information from the database 102.

Having stored this information in connection with the digital badge 202, the system can easily change any of the parameters as necessary without creating a new badge. Thus, if the facility wants to change an admittee's hours of access, days of access, area of access, and the like, the system can easily do so by accessing and modifying the information associated with the digital badge 202. The information is instantly updated without the admittee having to do anything extra.

Once the information associated with the admittee is inputted into the database 102 and associated with the admitted digital badge 202, the digital badge 202 may be delivered to the admittee's client device 200, such as a smartphone, tablet, phablet, personal digital assistant, smart watch, and the like for ready access. The digital badge 202 can be sent electronically to the admittee for receipt on the admittee's client device 200. The system can deliver the digital badge 202 using a variety of communication modes, such as an email, an email attachment, a text, a text attachment, and the like. Once received by the admittee, the admittee can store the digital badge 202 in an electronic file on his or her client device 200 for ready access.

In some embodiments, the system can deliver the digital badge 202 to the admittee by providing a secure website from which the admittee may be able to download the digital badge 202. For example, the admittee may be allowed to log onto the system's website with instruction as to how to download his or her specific digital badge from the website onto the admittee's selected client device 200. In some embodiments, the system may establish an app that can be downloaded onto the admittee's client device 200. The admittee can launch the app to display the digital badge 202.

Once the digital badge 202 is incorporated into the admittee's client device 200, the system can control access and monitor the admittee's admittance-related activities, such as which sites the admittee has visited and when the admittee has visited and left those sites. For example, the system can monitor each time an employee clocks in and clocks out at the beginning of the day, the end of the day, at the beginning of a break, and at the end of the break, etc. As employees are tracked when they begin and end work, an employer can more accurately manage time and payment of the employees. In addition, the employer can perform multi-employee, multi-group, and department transfers.

The digital badge 202 also makes it easier for the admittee to conduct administrative tasks. For example, clocking in and out would simply require having the digital badge 202 scanned by the reader 400. Using the digital badge 202, the admittee may be able to access, input, and modify certain limited information regarding the admittee. For example, an employee can submit tune off requests, sick leave, vacation requests, personal leave, and the like. Doing so may automatically update the restrictions on admittance associated with that badge so that the admittee does not have access to the facility when he or she was not planning to be there. The employee can also input tips, bonuses, and the like.

The system can track each of these types of information for each admittee as well as other types of tracking data. For example, for an employee, the employer can track data related to the employee's performance.

In some embodiments, a kiosk may be provided where the admittee can scan his or her digital badge 202 and input, update, or edit any of the information to which the admittee has access.

Readers 400 configured to read the digital badge 202 may be positioned at specific locations. In some embodiments, the reader 400 may be a fixed reader 400b conveniently positioned so that the admittee can simply walk past the reader 400 and have it automatically read the digital badge 202. In some embodiments, as authorized administrator may be equipped with a handheld reader 400a to physically scan each digital badge 202. In some embodiments, the readers 400 may be incorporated into certain authorized administrator's electronic devices, such as a smartphone, tablet, phablet, personal digital assistant, and the like. Thus, any authorized personnel carrying his or her smartphone, tablet, phablet, personal digital assistant, and the like, could scan a digital badge 202 with the pre-installed camera at any time to access various information from the admittee.

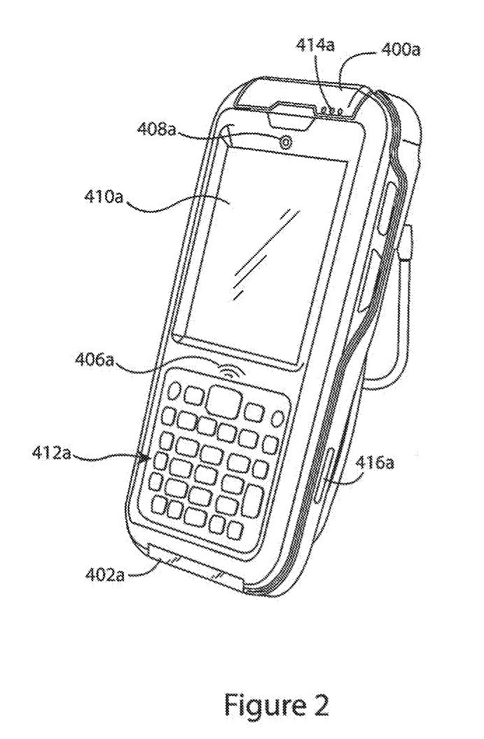

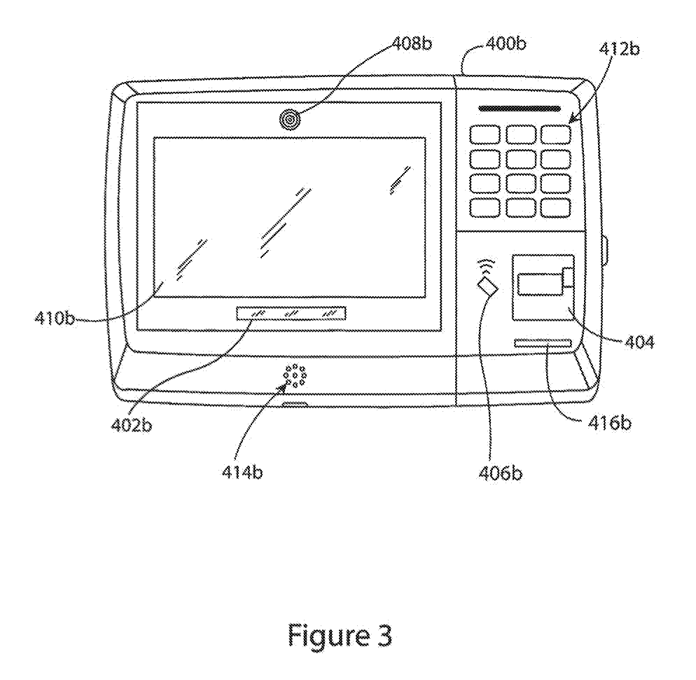

By way of example only, the reader 400 may comprise a processor and memory to process data and execute stored commands, and an operating system to interface with the user. As shown in FIGS. 2 and 3, the reader 400a, 400b also has a scanner 402a, 402b to read the digital barcode 202 of an admittee. For example, the scanner 402a, 402b may be a barcode scanner that enables quick and efficient scanning of traditional and two-dimensional barcodes (for example QR codes), even when displayed on a screen 204 of the client device 200, such as a smartphone screen, a smart watch screen, a PDA screen, a tablet screen, and the like. The barcode scanner may be a 1-D imager, a 2-D imager or a laser imager. In some embodiments, the scanner 402a may be incorporated in an authorized personnel's mobile device, such as his or her own smartphone, personal digital assistant, tablet, and the like. In such an embodiment, the camera pre-installed on the mobile device can be used as the scanner 408a.

In some embodiments, the reader 480 may be equipped with a biometric reader 404 (e.g., a fingerprint scanner, or a retinal or iris scanner), a proximity reader, or a smart card reader 406a,406b (such as the HID® reader), a camera 408a, 408b (such as a CCD camera), or any combination thereof, instead of or in addition to the scanner 402a, 402b. Any of these features can be incorporated into the handheld reader 400a or the fixed reader 400b.

The reader 400 may further comprise a communication system that can use wireless network connectivity to automatically push data to the system in real time or periodically, such as WWAN, WLAN, USB, Bluetooth, GPS, Ethernet, and the like. A web service may be configured to allow for seamless communication between the reader 400 and the server 100. The web service may implement multiple levels authentication.

In some embodiments, the reader 400 may have internal storage to store data. The server 100 and the reader 400 can automatically synchronize the data on a periodic schedule or whenever information changes. This allows the reader 400 to continue to perform its function even if the communication system stops functioning. In addition, any software updates to the reader can be performed automatically without having to bring the reader 400 to a dedicated location for service, repair, or updates.

The reader 400 may further comprise a screen 410a, 410b to display various information for the authorized personnel. In the preferred embodiment, the screen 410a, 410b may be a touchscreen. In some embodiments, the screen 410a, 410b can function as the biometric reader.

In some embodiments, the reader 400 may comprise a keyboard and/or a keypad 412a, 412b, speaker 414a, 414b, memory expansion slot 416a, 416b, rechargeable batteries, and the like at any convenient or typical location on the reader 400.

For handheld readers 400a, the authorized administrator can bring the reader 400a to the client device 200 and read the digital barcode 292, or the biometric data. In embodiments in which the reader 408 is fixed, the reader 400b is mounted at a particular location that serves as a gateway to the restricted site, admittee simply walks past the fixed reader 400b close enough to allow the fixed reader 400b to capture or read the barcode, or the admittee places the appropriate body part adjacent to the scanner, such as the finger or the eye.

The data that is read by the reader 488 is then transmitted to the server 100 for processing to determine the identification of the admittee and his or her access limitations, if any, for accessing a particular site. Alternatively, the access limitation information may be stored on the reader, embedded in the barcode, or any combination of the aforementioned.

Systems, apparatus, and methods described herein may be used within a network-based cloud computing system. In such a network-based cloud computing system, a server 108 or another processor that is connected to a network 300 communicates with one or more client devices 280 via a network 300. For example, a client device 288 may communicate with the server 100 via a network browser application residing and operating on the client device 200. A client device 200 may store certain accessible data on the server 100 and access the data via the network 300. A client device 200 may transmit requests for data, or requests for online services, to the server its via the network 300. The server 108 may perform requested services and provide data to the client device 200. Certain steps of the methods described herein may be performed by a server 100 or by another processor in a network-based cloud-computing system. Certain steps of the methods described herein may be performed by a client device 200 in a network-based cloud computing system. The steps of the methods described herein may be performed by a server 100 and/or by a client device 200 in a network-based cloud computing system, in any combination.

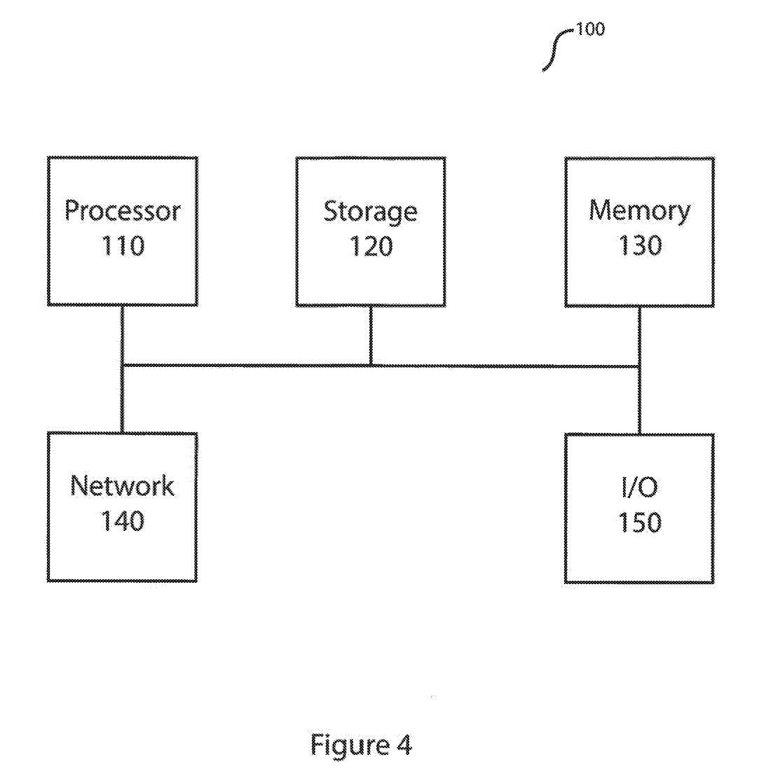

A high-level block diagram of an exemplary server 100 that may be used to implement systems, apparatus, and methods described herein is illustrated in FIG. 4. The server 100 comprises a processor 110 operatively coupled to a data storage device 120 and memory 130. Processor 110 controls the overall operation of server 100 by executing computer program instructions that define such operations. The computer program instructions may be stored in data storage device 120, or other non-transitory computer readable medium, and loaded into memory 130 when execution of the computer program instructions is desired. Thus, the method described herein can be defined by the computer program instructions stored in memory 130 and/or data storage device 120 and controlled by processor 110 executing the computer program instructions.

For example, the computer program instructions can be implemented as computer executable code programmed by one skilled in the art to perform the steps described herein. Server 100 also includes one or more network interfaces 140 for communicating with other devices via a network 300. Server 100 also includes one or more input/output devices 150 that enable user interaction with server 100 (e.g., display, keyboard, touchpad, mouse, speakers, buttons, etc.).

Processor 110 can include, among others, special purpose processors with software instructions incorporated in the processor design with instructions in storage device 120 or memory 130, to control the processor 110, and may be the sole processor or one of multiple processors of computer 100. Processor 110 may be a self-contained computing system, containing multiple cores or processors, a bus, memory controller, cache, etc. A multi-core processor may be symmetric or asymmetric. Processor 110, data storage device 120, and/or memory 130 may include, be supplemented by, or incorporated in, one or more application-specific integrated circuits (ASICs) and/or one or more field programmable gate arrays (FPGAs). It can be appreciated that the disclosure may operate on a computer 100 with one or more processors 110 or on a group or cluster of computers networked together to provide greater processing capability.

Data storage device 120 and memory 130 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Network/communication interface 140 enables the server 100 to communicate with networks 300, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 140 enables the computer 100 to transfer data, synchronize information update software, or any other suitable operation.

Input/output devices 150 may include peripherals, such as a printer, scanner, monitor, etc. Input/output devices 150 may also include parts of a computing device, such as a smartphone having a touchscreen, speakers, and buttons. For example, input/output devices 150 may include a display device such as a liquid crystal display (LCD) monitor for displaying information to the user, a keyboard and mouse by which the user can provide input to the sever 100, or a touchscreen for both input and output.

Any or all of the systems and apparatus discussed herein, including personal computers, tablet computers, hand-held devices, including smartphones, servers, database, cloud-computing environments, and components thereof, may be implemented using a computer such as computer 100.

One skilled in the art will recognize that an implementation of an actual computer or computer system may have other structures and may contain other components as well, and that FIG. 4 is a high level representation of some of the components of such a computer for illustrative purposes.

The foregoing description of the preferred embodiment of the invention and the details regarding the invention and FIGS. 1-4, attached hereto, has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of providing digital security clearance for a user, comprising:
a. generating a digital badge embedded with user information selected from the group consisting of identification information, effective time period information, and security credentials;
b. providing the digital badge to the user; and
c. authenticating the digital badge at a reader located at a site, wherein the authentication step requires the digital badge be accessed from a phone matching the user's phone number.

2. The method of claim 1, further comprising receiving a request from a client device to generate the digital badge.

3. The method of claim 2, further comprising electronically sending the digital badge to the client device.

4. The method of claim 3, further comprising receiving verification from a reader that has scanned the digital badge on the client device.

5. The method of claim 4, wherein the digital badge is a two-dimensional barcode image.

6. The method of claim 5, wherein when the barcode image is scanned by the reader, a computer displays select information embedded in the barcode image.

7. The method of claim 6, wherein the authentication step comprises verifying the identity of the user.

8. The method of claim 7, wherein the user information can be changed without creating a new digital badge.

9. The method of claim 7, wherein the verification step requires the electronic badge be flagged so that the user must be verified by security personnel.

10. The method of claim 9, wherein the digital badge is sent to the user via a communication mode selected from the group consisting of an email, a text, a website, and an app.

11. A system for providing digital security clearance for a user, comprising:
a. a server storing information regarding an admittee; and
b. a reader in communication with the server, the reader configured to read a digital badge displayed on a client device of the admittee, the reader comprising a biometric reader, a proximity reader, a smart card reader, and a camera.

12. The system of claim 11, further comprising a kiosk where the admittee's digital badge can be scanned.

13. The system of claim 12, further comprising a computer to input, update, or edit any information associated with the digital badge to which the user has access.

14. The system of claim 11, wherein the reader is selected from the group consisting of a fixed scanner, a handheld scanner, and a mobile device.

15. The system of claim 14, wherein the reader further comprises a communication system to transmit data collected from the digital barcode to the server to access information associated with the digital barcode.

16. A method of providing digital security clearance for a user, comprising:
a. generating a digital badge embedded with user information selected from the group consisting of identification information, effective time period information, and security credentials;
b. providing the digital badge to the user;
c. authenticating the digital badge at a reader located at a site, wherein the authentication step requires the digital badge be accessed from a phone matching the user's phone number;
d. receiving a request from a client device to generate the digital badge;
e. electronically sending the digital badge to the client device;
f. receiving verification from a reader that has scanned the digital badge on the client device, wherein the digital badge is a two-dimensional barcode image, wherein when the barcode image is scanned by the reader, a computer displays select information embedded in the barcode image, wherein the authentication step comprises verifying the identity of the user, and wherein the verification step requires the electronic badge be flagged so that the user must be verified by security personnel.
